(19) United States
(12) Patent Application Publication
(10) Pub. No.: US 2004/0027519 A1
(43) Pub. Date: Feb. 12, 2004

(54) Color compensating structure of semireflecting liquid crystal display and a method for manufacturing the structure

(76) Inventors: Po-Hsien Wang, Hsin-Tien City (TW); Yi-Fan Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/212,777

(22) Filed: Aug. 7, 2002

(51) Int. Cl. G02F 1/1335

(52) U.S. Cl. 349/117

(57) ABSTRACT

A color compensating structure of semireflecting liquid crystal display and a method for manufacturing the structure. A structure includes an upper insulating substrate and a lower insulating substrate between which a liquid crystal layer is disposed. A semireflecting film is plated on the lower insulating substrate. A color light filtering film and a resin protective layer are sequentially disposed on the semireflecting film. The color light filtering film is formed of light resistor with high color saturation. A total reflecting film is plated on the protective layer and patterned.

### BACKGROUND OF THE INVENTION

A present invention is related to a color compensating structure of semireflecting liquid crystal display and a method for manufacturing the structure. In the color compensating structure, a semireflecting film, a color light filtering film and a patterned total reflecting film are disposed on a same substrate. In both penetrating mode and reflected mode, the color compensating structure compensates color saturation and brightness of white light.

FIG. 4 shows a conventional semireflecting liquid crystal display which reflects a light beam in a reflecting mode. A liquid crystal layer 73 is disposed between the upper and lower insulating substrates 71, 72. In addition, a color light filtering film 74 and a semireflecting film 75 are disposed between the liquid crystal layer 73 and the lower insulating substrate 72. A back light source 76 is arranged on outer side of the lower insulating substrate 72.

In reflecting mode, the light beam goes into the upper insulating substrate 71 and passes through the liquid crystal layer 73 and the color light filtering film 74. The light beam is then reflected by the semireflecting film 75 to again pass through the color light filtering film 74 and the liquid crystal layer 73. The light beam then goes out from the upper insulating substrate 71. In this reflecting mode, the light beam twice passes through the color light filtering film 74 so that the color light filtering film 74 must be made of light resistor with lower color saturation. Therefore, the brightness of the reflected light beam will not be insufficient.

Referring to FIG. 5, in penetrating mode, the light beam is projected from the back light source 76 and then sequentially passes through the lower insulating film 72, semireflecting film 75, color light filtering film 74 and the liquid crystal layer 73. Then the light beam goes out from the upper insulating substrate 71. However, the color light filtering film 74 is made of light resistor with lower color saturation. Therefore, in penetrating mode, the color saturation of the penetrating light beam will be insufficient.

In the case that the light filtering film 74 is made of light resistor with higher color saturation for solving the problem of insufficient color saturation of the penetrating light beam, the brightness of the reflected light beam will be insufficient.

FIG. 6 shows a brightening structure disclosed in U.S. Pat. No. 6,215,538 of Japanese company “Sharp”. In the brightening structure, a liquid crystal layer 83 is disposed between the upper and lower insulating substrates 81, 82. A layer of reflecting electrode 84 is laid on the lower insulating substrate 82. In addition, a patterned color light filtering film 85 and a transparent electrode 86 are disposed on the upper insulating substrate 81. A portion of the transparent electrode 86 aligned with the reflecting electrode 84 forms a colorless area B. The color light filtering film 85 is made of a light resistor with higher color saturation.

According to such structure, in penetrating mode, the color light filtering film 85 with high color saturation makes the penetrating light beam have sufficient color saturation. In reflected mode, the white light reflected from the colorless area B compensates the insufficient brightness of the reflected light beam.

However, the color light filtering film 85 and the reflecting electrode 84 are respectively disposed on the upper and lower insulating substrates 81, 82. Therefore, when assembled, it is necessary to accurately align the color light filtering film 85 and the reflecting electrode 84. This increases the difficulty in manufacturing procedure. In case of a greater error of alignment of the color light filtering film 85 with the reflecting electrode 84, a light leakage will take place in the penetrating mode. This will result in insufficient color saturation.

### SUMMARY OF THE INVENTION

It is therefore a primary object of the present invention to provide a color compensating structure of semireflecting liquid crystal display and a method for manufacturing the structure. A color light filtering film formed of the light resistor with higher color saturation is disposed on the surface of the semireflecting film on the lower insulating substrate. A patterned total reflecting film is plated on the protective layer of the color light filtering film. The color light filtering film formed of the light resistor having high color saturation serves to enhance the color saturation of the light beam in penetrating mode. However, the brightness of the light beam is reduced. In addition, the patterned total reflecting film serves to enhance the brightness of white light in reflected mode. Therefore, a good color compensating effect can be achieved.

It is a further object of the present invention to provide the above color compensating structure and the method for manufacturing the structure in which the semireflecting film, color light filtering film and total reflecting film are disposed on the same substrate. Therefore, it is unnecessary to accurately align the upper and lower insulating substrates with each other. Moreover, the total reflecting film is disposed on the color light filtering film so that it is unnecessary to pattern the color light filtering film for the brightness of totally reflected white light. Therefore, the manufacturing procedure is simplified and the manufacturing cost is lowered.

It is still a further object of the present invention to provide the above color compensating structure and the method for manufacturing the structure in which when splash plating the semireflecting film, the thickness of the film can be adjusted to vary the penetrability. Accordingly, the brightness of the displayed picture in penetrating mode and reflected mode can be controlled.

The present invention can be best understood through the following description and accompanying drawings wherein:

### BRIEF DESCRIPTION OF THE DRAWINGS

FIG. 1 is a block flow chart of the manufacturing method of the present invention;

FIG. 2 shows the manufacturing procedure of the present invention;

FIG. 3 shows the projection and reflection of the light beam in penetrating mode and reflected mode of the present invention;

FIG. 4 shows the reflection of the light beam in reflected mode of a conventional semireflecting liquid crystal display;

FIG. 5 shows the projection of the light beam in penetrating mode of the conventional semireflecting liquid crystal display; and

FIG. 6 shows a conventional brightening structure of a liquid crystal display.

### DETAILED DESCRIPTION OF THE PREFERRED EMBODIMENTS

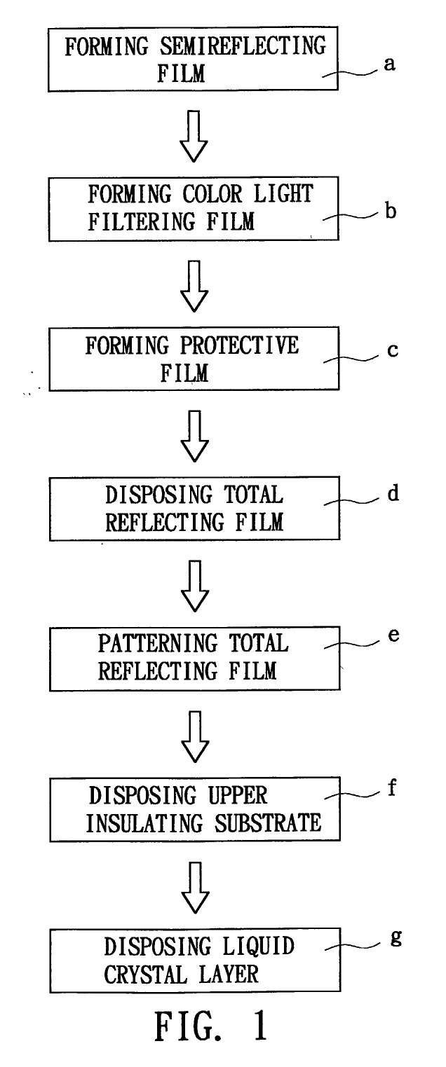

Please refer to FIGS. 1 to 3. The method for manufacturing color compensating structure of semireflecting liquid crystal display of the present invention includes steps of:

a. forming semireflecting film:

A semireflecting film 12 is plated on a lower insulating substrate 11 by way of splash plating. The semireflecting film 12 can be a film of alloy of gold, silver, copper, aluminum, palladium, etc. or a nonmetallic multilayer film. The semireflecting film 12 has a thickness within 10 nm˜500 nm. The semireflecting film 12 has a penetrability within 5%˜80%.

b. forming color light filtering film:

A red light resistor is painted on the semireflecting film 12. Through the procedures of exposure, development, baking and patterning, a red subpixel 13a is formed on each pixel. Then a green light resistor is painted on the semireflecting film 12. Through the procedures of exposure, development, baking and patterning, a green subpixel 13b is formed on each pixel adjacent to the red subpixel. Then, a blue light resistor is painted on the semireflecting film 12. Through the procedures of exposure, development, baking and patterning, a blue subpixel 13c is formed on each pixel adjacent to the green subpixel 13b. The red, green and blue subpixels 13a, 13b, 13c on each pixel together form a color light filtering film 13. The light resistors with the respective colors all have high color saturation.

c. forming protective layer:

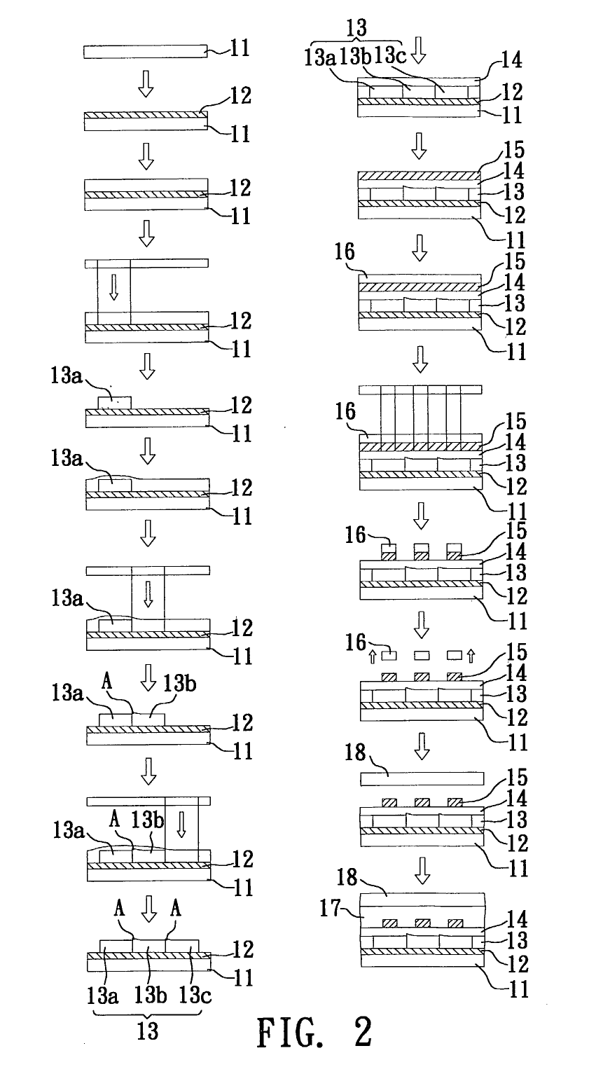

A protective layer 14 of resin material is painted on the surface of the color light filtering film 13. In step b, when painting the light resistors with the respective colors, the previously formed light filtering film will be covered. Therefore, the adjoining sections of the painted light resistor and the adjacent light filtering film will slightly swell. After exposed and developed, a slightly protruding section will be produced as denoted by A in FIG. 2. When painting the protective layer 14, the protective layer 14 will plane the protruding sections A between the red, green and blue light filtering films 13a, 13b, 13c and thus plane the color light filtering film 13.

d. disposing total reflecting film:

A total reflecting film 15 is splash plated on the protective layer 14. The total reflecting film 15 can be a film of alloy of gold, silver, copper, aluminum, palladium, etc. or a nonmetallic multilayer film. The total reflecting film 15 has a thickness within 10 nm˜500 nm.

e. patterning the total reflecting film:

A layer of light resistor 16 is painted on the total reflecting film 15. By means of a patterned optical mask, through the procedures of exposure, development and etching, the total reflecting film 15 and the light resistor 16 are both patterned. Then the light resistor 16 is removed to obtain a patterned total reflecting film 15.

f. disposing upper insulating substrate:

An upper insulating substrate 18 is disposed on the total reflecting film 15. In addition, multiple electrodes are formed on the upper insulating substrate.

g. disposing liquid crystal layer:

A liquid crystal layer 17 is disposed between the total reflecting film 15 and the upper insulating substrate 18. The liquid crystal layer 17 has a phase difference Δnd within 700 nm˜900 nm.

By means of the above method, a color compensating structure of semireflecting liquid crystal display can be made. The color compensating structure includes an upper insulating substrate 18 and a lower insulating substrate 11. A semireflecting film 12 is plated on the lower insulating substrate 11. A color light filtering film 13 is disposed on the semireflecting film 12. The color light filtering film 13 is formed of light resistor with high color saturation. A protective layer 14 is disposed on the color light filtering film 13. A patterned total reflecting film 15 is plated on the protective layer 14. A liquid crystal layer 17 is disposed between the total reflecting film 15 and the upper insulating substrate 18.

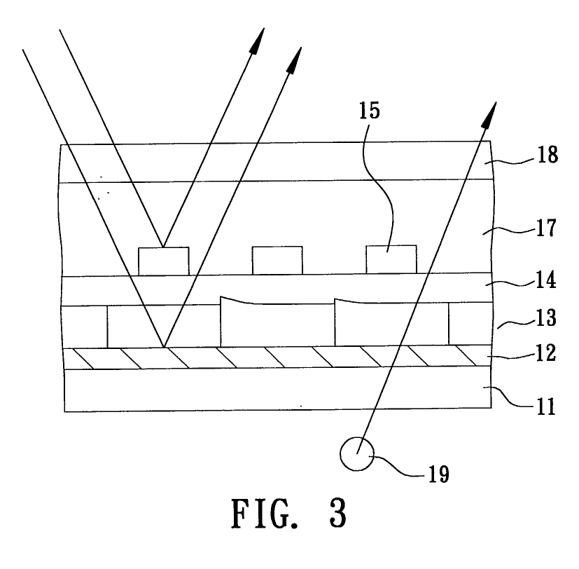

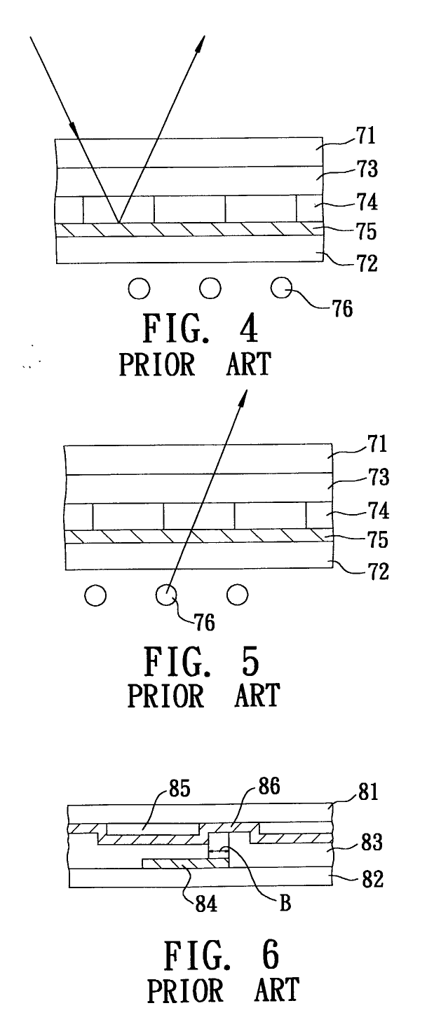

In actual use, a back light source 19 is arranged on one side of the lower insulating substrate 11. Referring to FIG. 3, in reflected mode, the light beam generated by the back light source 19 goes into the upper insulating substrate 18 and passes through the liquid crystal layer 17, protective layer 14 and color light filtering film 13 and is reflected by the semireflecting film 12. The light beam then again passes through the color light filtering film 13, protective layer 14 and liquid crystal layer 17 and goes out from the upper insulating substrate 18. The color light filtering film 13 is formed of the light resistor with higher color saturation so that the light beam reflected from the color light filtering film 13 has higher color saturation. However, the brightness of the light beam is reduced. However, a part of the light beam going from the upper insulating substrate 18 into the liquid crystal layer 17 does not go into the color light filtering film 13 and is reflected by the total reflecting film 15 as white light. The white light serves to compensate the brightness so that in reflected mode, the brightness and color saturation can be both considered.

In penetrating mode, the light beam is projected from the back light source 19 and sequentially passes through the lower insulating substrate 11, semireflecting film 12, color light filtering film 13, protective layer 14 and liquid crystal layer 17 and then goes out from the upper insulating substrate 18. The filtering film 13 is formed of the light resistor with higher color saturation so that the penetrating light beam has higher color saturation.

According to the above, no matter in reflected mode or in penetrating mode, the color compensating structure of the present invention can provide a considerable color compensating effect so as to keep sufficient color saturation and brightness.

Furthermore, the semireflecting film 12, color light filtering film 13 and total reflecting film 15 are all disposed on the lower insulating substrate 11 so that it is unnecessary to perform any accurate alignment. Therefore, the manufacturing procedure is simplified and the problem of leakage of light due to poor alignment can be avoided.

The protective layer 14 painted on the color light filtering film 13 serves to plane the protruding sections A of the red, green and blue light filtering films 13a, 13b, 13c so as to achieve better reflecting effect.

When splash plating the semireflecting film 12, the thickness of the film can be varied to adjust the penetrability. Accordingly, the brightness of the displayed picture in penetrating mode and reflected mode can be controlled to meet the requirement in use.

The above embodiments are only used to illustrate the present invention, not intended to limit the scope thereof. Many modifications of the above embodiments can be made without departing from the spirit of the present invention.

What is claimed is:

1. A color compensating structure of semireflecting liquid crystal display, comprising an upper insulating substrate and a lower insulating substrate, the upper insulating substrate being formed with multiple electrodes, a semireflecting film being plated on the lower insulating substrate, a color light filtering film being disposed on the semireflecting film, the color light filtering film being formed of light resistor with high color saturation, a protective layer being disposed on the color light filtering film, a patterned total reflecting film being plated on the protective layer, a liquid crystal layer being disposed between the total reflecting film and the upper insulating substrate.

2. The color compensating structure of semireflecting liquid crystal display as claimed in claim 1, wherein the semireflecting film has a thickness within 10 nm˜500 nm.

3. The color compensating structure of semireflecting liquid crystal display as claimed in claim 1, wherein the semireflecting film has a penetrability within 5%˜80%.

4. The color compensating structure of semireflecting liquid crystal display as claimed in claim 1, wherein the total reflecting film has thickness within 10 nm˜500 nm.

5. The color compensating structure of semireflecting liquid crystal display as claimed in claim 1, wherein the liquid crystal layer has a phase difference Δnd within 700 nm˜900 nm.

6. A method for manufacturing color compensating structure of semireflecting liquid crystal display, comprising steps of:
forming semireflecting film, a semireflecting film being formed on a lower insulating substrate;
forming color light filtering film, numerous red, green and blue subpixels being formed on the semireflecting film, the red, green and blue subpixels respectively forming numerous pixels which together form a color light filtering film;
forming protective layer, a protective layer made of resin material being painted on the surface of the color light filtering film;
disposing total reflecting film, a total reflecting film being splash plated on the protective layer;
patterning the total reflecting film, by means of development and etching, the total reflecting film being patterned;
disposing upper insulating substrate, an upper insulating substrate being disposed on the total reflecting film; and
disposing liquid crystal layer, a liquid crystal layer being disposed between the total reflecting film and the upper insulating substrate.

7. A method for manufacturing color compensating structure of semireflecting liquid crystal display as claimed in claim 6, wherein in the step of forming semireflecting film, the semireflecting film is plated on the lower insulating substrate by way of splash plating, the semireflecting film being a film of alloy of gold, silver, copper, aluminum, palladium, etc. or a nonmetallic multilayer film.

8. The method for manufacturing color compensating structure of semireflecting liquid crystal display as claimed in claim 6, wherein in the step of patterning total reflecting film, a layer of light resistor is painted on the total reflecting film, by means of a patterned optical mask, through the procedures of exposure, development and etching, the total reflecting film and the light resistor being both patterned, then the light resistor being removed to obtain a patterned total reflecting film.

9. The method for manufacturing color compensating structure of semireflecting liquid crystal display as claimed in claim 6, wherein in the step of disposing upper insulating substrate, multiple electrodes are formed on the upper insulating substrate.
